(19) United States
(12) Patent Application Publication
(10) Pub. No.: US 2011/0185605 A1
(43) Pub. Date: Aug. 4, 2011

(54) License plate security lock

(76) Inventor: Steve Parenti, Newark, CA (US)

(21) Appl. No.: 12/658,141

(22) Filed: Feb. 3, 2010

(51) Int. Cl. E05B 65/00; B60R 13/10

(52) U.S. Cl. 40/202

(57) ABSTRACT

A license plate security device comprises a slip collar into which a license plate mounting machine screw is inserted. These are inserted into a spin barrel assembly with a closed bottom and an open top. The license plate is installed on the vehicle using at least one of these license plate security devices, more machine screws, and an ordinary screwdriver. A cabinet style key lock is inserted into the open end of the spin barrel and covers the head of the machine screw. A weather cap is snapped over the lock and spin barrel to keep out dirt, water, and ice. Removing the license plate now requires a key to remove the lock from the spin barrel to access the head of the machine screw. Turning the spin barrel only will not remove the machine screw because the collar creates a slip joint and will not transmit enough torque.

### BACKGROUND OF THE INVENTION

1. Field of the Invention

The present invention relates to vehicle license plate security devices, and in particular to locking devices that deny access to one or more of the fasteners mounting a license plate to a vehicle.

2. Description of the Prior Art

License plates on cars are easy to install and remove. Most often just four screws hold them on and an ordinary screw driver is all you need for the job. Car thieves, gas station pump-and-run thieves, and bank robbers all now seem to assume a freshly stolen license plate will help throw the police off the trail if their cars are spotted. The police will pounce on innocent victims and presuppose the victims are the true subjects until proven otherwise.

The victims of license plate thefts are often unaware of the loss until a traffic officer stops them and cites them. Replacing the missing licenses and tags requires more fees to be paid and a trip to the DMV offices. Such offices are usually inhospitable, quite distant, have long waiting lines, and their business hours coincide with the victim's job shift. Getting cited means paying fines and making court appearances.

What is needed is a license plate security device that is strong, includes a high quality lock, and covers one or more of the mounting screws. Removing the plate should require the use of a key.

### SUMMARY OF THE INVENTION

Briefly, a license plate security device embodiment of the present invention comprises a slip collar into which a license plate mounting machine screw is inserted. The slip collar and license plate mounting machine screw are inserted into a spin barrel assembly with a closed bottom and an open top such that the license plate mounting machine screw protrudes through a small hole in the bottom. The license plate is installed on the vehicle using at least one of these license plate security devices, more machine screws, and an ordinary screwdriver. A cabinet style key lock is inserted into the open end of the spin barrel and covers the head of the machine screw. A weather cap is snapped over the lock and spin barrel to keep out dirt, water, and ice. Removing the license plate now requires a key to remove the lock from the spin barrel to access the head of the machine screw. Turning the spin barrel only will not remove the machine screw because the collar creates a slip joint and will not transmit enough torque.

These and other objects and advantages of the present invention will no doubt become obvious to those of ordinary skill in the art after having read the following detailed description of the preferred embodiments which are illustrated in the various drawing figures.

### IN THE DRAWINGS

FIG. 1 is an exploded assembly view diagram of a license plate security device embodiment of the present invention;

FIG. 2 is a front view diagram of a license plate security device embodiment of the present invention installed and securing a license plate and its frame;

FIG. 3 is perspective view diagram of a license plate security frame and mounting bar that can be used for commercial vehicles where the nuts for the mounting screws would otherwise be exposed and vulnerable;

FIG. 4 is an exploded assembly view diagram of a license plate security device embodiment of the present invention showing the spin barrel and license plate in cross-section view;

FIG. 5 is an exploded assembly view diagram of a license plate security device embodiment of the present invention showing an external weather cap in cross-section view installed on a lock and spin barrel; and

FIG. 6 is an exploded assembly and cross-sectional view diagram of a license plate security device embodiment of the present invention showing an insert weather cap installed in a rim groove on a lock and spin barrel.

### DETAILED DESCRIPTION OF THE PREFERRED EMBODIMENT

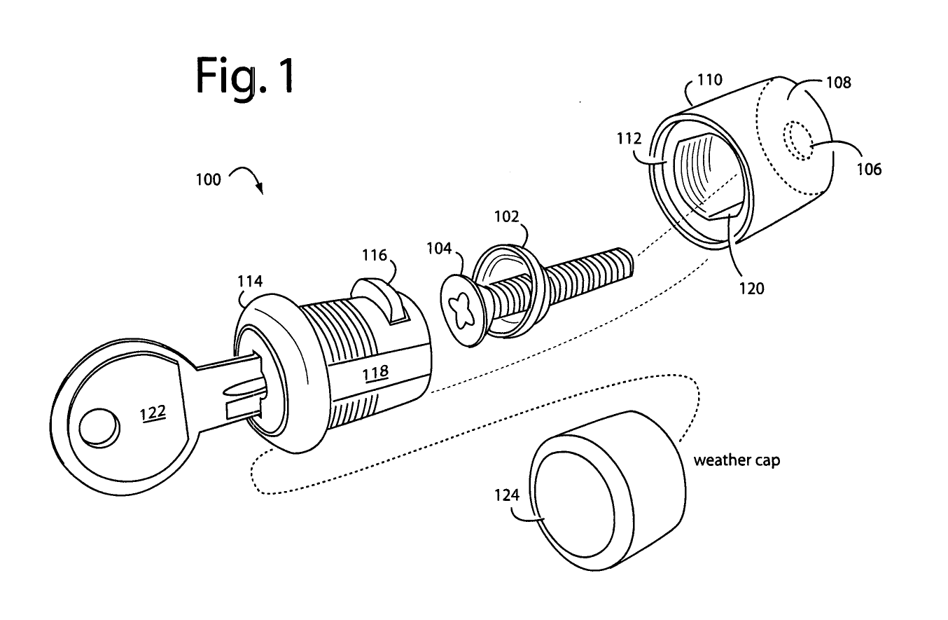

FIG. 1 represents a license plate security device embodiment of the present invention, and is referred to herein by the general reference numeral 100. The license plate security device 100 is intended to make at least one license plate mounting bolt inaccessible to tools unless the matching key is on-hand.

License plate security device 100 typically comprises a slip collar 102 into which a license plate mounting machine screw 104 can be inserted through a hole 106 in a closed end 108 of a spin barrel assembly 110. The spin barrel assembly 110 is generally in the form of a hollow cylinder with the closed bottom 108 and an open top 112.

The slip collar 102 includes a spacer that keeps machine screw 104 from clamping down hard on the closed end 108 of spin barrel assembly 110. Therefore, even if machine screw 104 is tight and clamping down on a license plate and/or its frame, the spin barrel assembly 110 around its head is free to turn.

A cabinet-style key lock 114 is sized to fit completely inside the open end 112 of the spin barrel 110 and to lock in place so as to deny tool access to the head of the license plate mounting machine screw 104. A locking pawl 116 and contoured side 118 are accommodated by a matching contouring and grooving profile 120 inside spin barrel 110.

So, the removal of a license plate secured by the license plate security device 100 thereafter requires a key 122 to remove the lock 114 from the spin barrel 110 to access the head of the machine screw 104. Simply turning the spin barrel 110 will not remove the machine screw 104 because the slip collar 102 in the spin barrel 110 creates a slip joint that will not transmit enough torque.

Once key 122 is taken out and secured, a removable weather cap 124 can be pressed by the user over the face of the cabinet-style key lock 114 and the open end 112 of the spin barrel 110. Such provides a seal to exclude water, dirt, and ice. The weather cap 124 can be configured at least two ways, one is to make weather cap 124 from rather soft compliant silicone rubber and size it to fit snugly and completely over spin barrel 110. A second way is to include a deep groove around the inside edge of spin barrel 110 and make weather cap 124 of rather hard, nylon-like plastic that fits inside like a plug surrounding lock 114. The second configuration would be more permanent and would typically require a tool to dig out the weather cap 124.

Key 122 can be a double-cut type that can be inserted either way, and it can be kept in the glove box of the car so it is on-hand when needed.

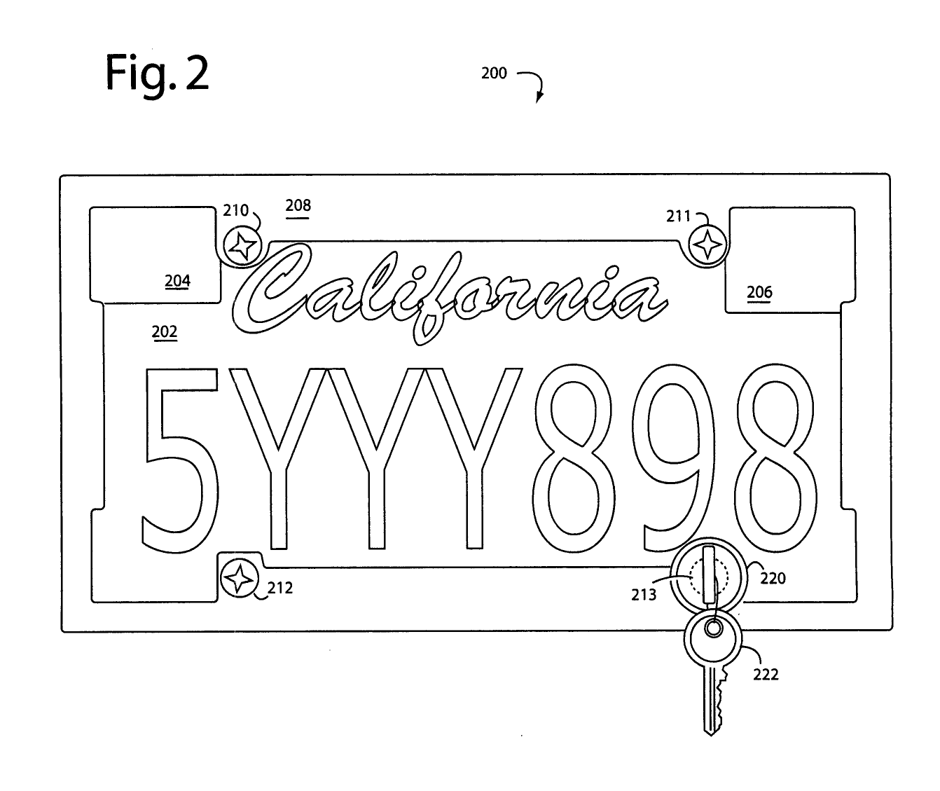

FIG. 2 represents an installed license plate assembly 200 as would be mounted on the rear of a car. A conventional license plate 202 with a year sticker 204 and a month sticker 206 are bordered by a frame 208 and fastened to the car with four machine screws 210-213. The fourth machine screw 213 is captured inside a license plate security device 220. A pair of keys 222 locks up the license plate security device 220 like that in FIG. 1. Any one of the machine screws 210-213 could be fitted with the license plate security device 220.

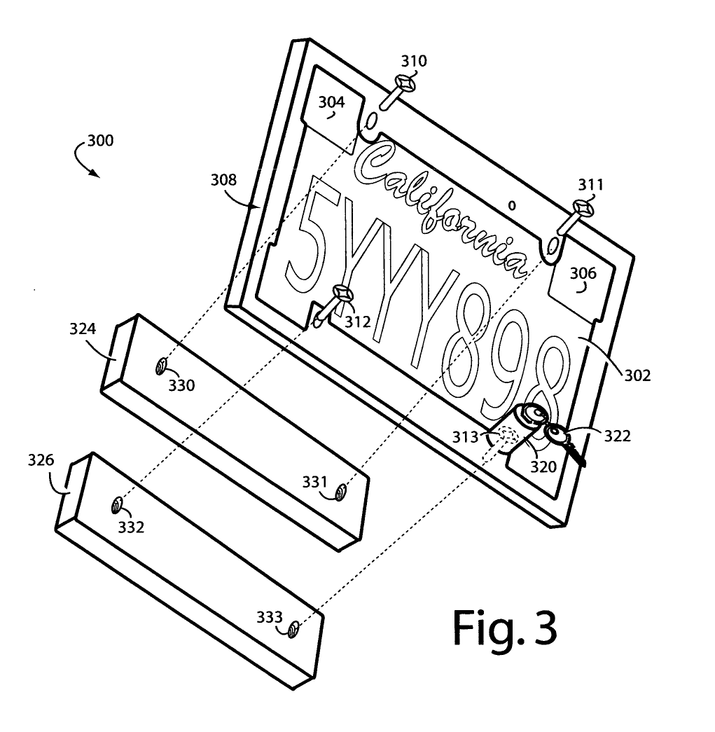

FIG. 3 illustrates a license plate security assembly 300 that would be used for a truck or any other application where nuts would ordinary be used on the backside and that would be exposed and easily removed. A conventional license plate 302 with a year sticker 304 and a month sticker 306 are bordered by a frame 308 and fastened to a fender bracket with four machine screws 310-313. The fourth machine screw 313 is captured inside a license plate security device 320. A pair of keys 322 locks up the license plate security device 320 like that in FIGS. 1 and 2. Any one of the machine screws 310-313 could be fitted with the license plate security device 320. The license plate security assembly 300 differs in that it uses one or two mounting bars 324 and 326 on the backside of a fender mounting bracket instead of machine nuts. These each have two threaded holes 330-333 sized and located to fit machine screws 310-313. Removing only one machine screw in a pair retaining either of mounting bars 324 and 326 will not be enough to free license plate 302 without keys 322.

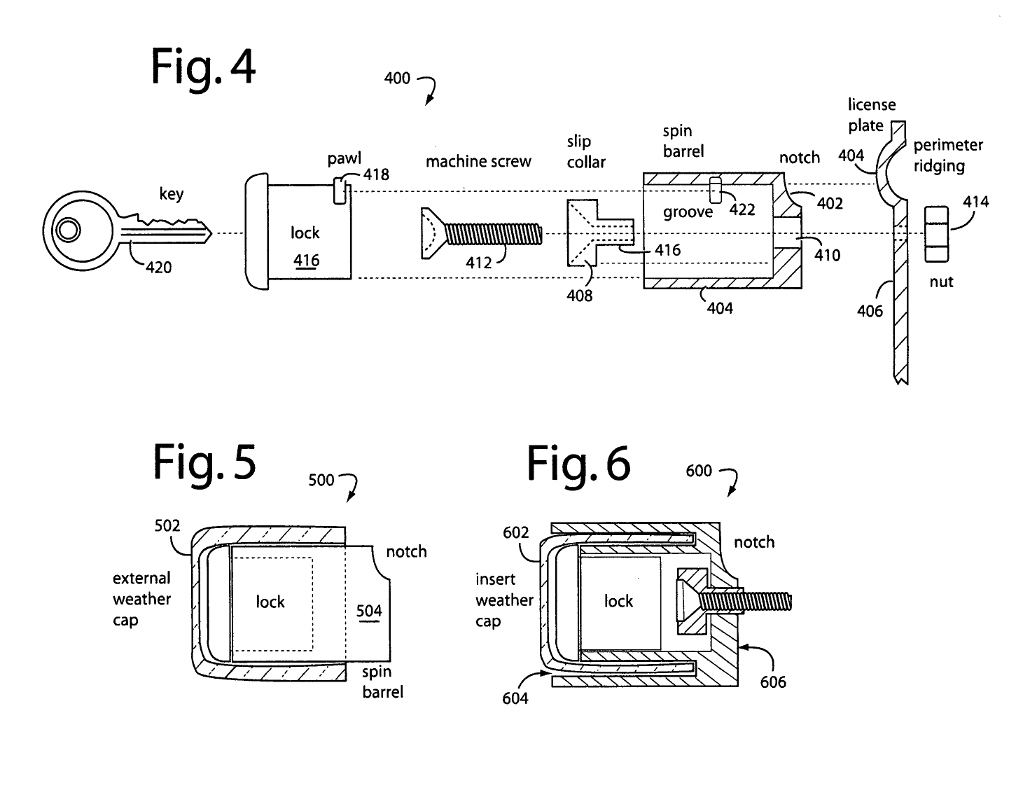

FIG. 4 represents a license plate security device 400 and is similar to license plate security device 100 in FIG. 1, and license plate security device 220 in FIG. 2, and license plate security device 320 in FIG. 3. The license plate security device 400 includes a notch 402 across one chord of the bottom of a spin barrel 404 that nests a perimeter ridging 404 on a license plate 406. A slip collar 408 drops down into a hole 410 and is tightly secured by a machine screw 412 and a nut 414. The slip collar 408 has a shoulder 416 that is just a little longer than that needed to accommodate the thickness of hole 410 in the bottom end of spin barrel 404. Spin barrel 404 can thus turn freely on slip collar 408 even though machine screw 412 is tightly fastened by nut 414 on license plate 406. A lock 416 has a pawl 418 that is activated by a key 420 and that engages a groove 422 inside the hollow cylinder of spin barrel 404.

FIG. 5 represents a license plate security device 500 in which a user removable external weather cap 502 has been pushed onto the free end of a lock and spin barrel 504. The external weather cap 502 in FIG. 5 is equivalent to weather cap 124 shown in FIG. 1. The external weather cap 502 can be made of pliable silicone rubber.

FIG. 6 represents a license plate security device 600 in which a user removable insert weather cap 602 has been pushed into a rim groove 604 in the free end of a lock and spin barrel 606. The insert weather cap 602 in FIG. 6 is alternative to the weather caps 124 and 502 shown in FIGS. 1 and 5. Since it fits fairly snugly into rim groove 604, it is a bit more protected and harder to remove than external weather cap 502 of FIG. 5. The insert weather cap 602 can be made of black nylon or ABS plastic.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

1. A license security device, comprising:
a slip collar and shoulder into which a license plate mounting machine screw can be inserted through;
a spin barrel assembly generally in the form of a hollow cylinder with a closed bottom and an open top;
a hole sized to accommodate the slip collar and shoulder in said closed bottom of the spin barrel; (and)
said shoulder being a little longer than the thickness of said hole; and
a cabinet-style key lock sized to fit completely inside said open end of the spin barrel and to lock in place so as to deny tool access to a head of said license plate mounting machine screw;
wherein, the removal of a license plate secured by the license plate security device thereafter requires a key to remove the lock from the spin barrel to access the head of the machine screw, and turning the spin barrel only will not remove the machine screw because the slip collar and shoulder in the spin barrel creates a slip joint that will not transmit enough torque.

2. The license plate security device of claim 1, further comprising:
a contouring and grooving of the inside dimensions of the spin barrel such that the cabinet-style key lock can be inserted and locked within.

3. The license plate security device of claim 1, further comprising:
a removable weather cap fit over the face of the cabinet-style key lock and said open end of the spin barrel, and providing a seal to exclude water, dirt, and ice.

4. The license plate security device of claim 1: further comprising:
a notch on the outside edge of the closed end of the spin barrel, and providing for a matching relief to a raised rim on the perimeter of a license plate secured by the license plate security device.

5. (canceled)

6. (canceled)

7. (canceled)

8. (canceled)
